(19) United States
(12) Patent Application Publication
(10) Pub. No.: US 2004/0191425 A1
(43) Pub. Date: Sep. 30, 2004

(54) Method of applying a relief inscription to a substrate made of plastic, and a device for implementing the method

(76) Inventor: Norbert Peytour, Montbrisson (FR)

Correspondence Address: NIXON & VANDERHYE P.C., 8th Floor, 1100 North Glebe Road, Arlington, VA, 22201, US

(21) Appl. No.: 09/986,648

(22) Filed: Nov. 9, 2001

(30) Foreign Application Priority Data
Nov. 10, 2000 (FR) 00 14 610

(51) Int. Cl. B05D 5/00

(52) U.S. Cl. 427/565; 427/256

(57) ABSTRACT

The present invention relates to a procedure for applying relief inscriptions in plastic material to a substrate, characterized in that it comprises:

a step in which a plastic material of variable viscosity is deposited in real time in a single operation, only at those places that form the relief inscription, at a sufficient temperature to ensure a physical-chemical bond with the material comprising the substrate,

a cooling step for the material deposited.

The present invention concerns a method of applying a relief inscription to a substrate made of plastic, and a method for implementing the method.

Methods of applying relief inscriptions, used in particular for applying relief inscriptions of information relating to the holder and the account number of the owner of a plastic card, such as debit cards or telephone cards or social security cards, or security cards or personal private cards, are known. The cards referred to as plastic can be smart cards, magnetic cards, badges, etc.

In the prior art, in order to apply inscriptions to substrates, a person skilled in the art had to use embossing, which presented problems, particularly in the field of plastic cards. Plastic cards containing an integrated circuit could not be embossed on the reverse in the zone housing the integrated circuit, and similarly, cards containing a magnetic strip could not be embossed on the reverse of the zone where the magnetic strip was located. Furthermore, the embossing had to be a compromise between the height of the characters, the thickness of the plastic substrate, and the rigidity and resistance of the characters when passed through machines to take their impression. It also resulted in a weakening of the strength of the substrate at the zone including the inscription, and did not allow a detailed impression on the reverse of the embossed surface.

Furthermore, a method of applying hot inscriptions, used in various industries such as printing, cardboard packaging, plastic articles and bookbinding, is known from European patent application 258 099. In this method, a traditional imprint is made on the substrate using a material, the surface of which remains wet, to form the image which is then converted into a relief. A relief conversion operation on this imprint is then carried out by the known method of thermography, which consists of sprinkling a flat imprint, the ink of which is still wet, with fusible powder that melts under the action of heat, an operation generally associated with infrared radiation, to form a semi-liquid film in relief that freezes when passed under a jet of cold air.

This printing technique involves using air extraction to remove the excess powder retained by the wet ink, and recycling this excess powder. It can readily be understood that this printing method does not allow a relief inscription of sufficient height to be obtained that is the equivalent of the relief inscription produced by embossing. Characters embossed in a plastic substrate have a width of the order of 800 microns, a length of 3 mm and a thickness of the order of 200 microns.

To deposit 200 microns on the substrate using the above technique, a number of passes would probably be necessary, since a single pass would not allow the wet ink to retain enough powder to reach this height. The printing operation also requires two steps: firstly, the transfer of an image with the aid of wet ink, and secondly the application of a fusible material to create the relief.

A printing head for the thermal transfer of thick varnish is also known from French patent application 2 735 994. This patent application discloses the deposition of varnish by means of thermal transfer, particularly to protect plastic cards. To achieve this, a thermal print head, of the type incorporating a heated tip, applies a ribbon coated with a layer of varnish, transferable under the effect of heat, to the surface to be varnished. Motion is imparted to the ribbon to give it relative movement past the print head. In this method, the ribbon is in contact with the plastic card and is intended to cover its entire surface. This method does not allow just a part of the surface to be covered, especially a part of a surface that vary from one plastic object to another depending on the information to be inscribed in relief on its surface.

A primary objective of the invention is thus to remedy the defects of the prior art.

This objective is achieved by the fact that the method of applying relief inscriptions to a plastic substrate comprises:

a step in which a plastic material of variable viscosity is deposited in real time in a single operation, only at those places that form the relief inscription, at a sufficient temperature to ensure a physical-chemical bond with the material comprising the substrate,

a cooling step for the material deposited.

According to another feature, the substrate is a magnetic card.

According to another feature, the substrate is a smart card.

According to another feature, the substrate is a badge.

According to another feature, the method comprises a control step for a number of vibrating elements in the form of tubes, supplied with fluidised plastic material from a reservoir, the vibration of these tubes being synchronised and controlled at frequencies to produce the deposition of drops of fluidised plastic material at the places necessary for a number of deposited drops to form an alphanumeric character, logo, increased thickness or any other form of raised area.

According to another feature, the relief inscription may constitute a bar code.

According to another feature, the relief inscription may constitute other codes carrying information concerning the substrate or the user of the substrate.

According to another feature, the control of the deposition of the drops is effected as a function of the speed at which the substrates pass by in front of the ends of the print heads.

Another objective is to propose a device for implementing the method.

This objective is achieved by the fact that the device incorporates a means of moving the substrate, made of plastic, in front of a print station equipped with a number of nozzles which eject drops of plastic material of variable viscosity, the ejector nozzles being fitted with a means of controlling the positioning of the drops in a direction transverse to that of the movement of the substrates, and also a means of controlling the ejection duration of each drop as a function of both the speed of travel of the substrates and the data constituting the inscription.

According to another feature, the device includes a cooling station for the fluidised plastic material or the material of variable viscosity.

According to another feature, the device includes a control unit connected to both the means of controlling the transfer speed of the substrates in front of the inscription station, and each of the ejector nozzles for the fluidised plastic material.

The control unit also includes connections to each of the heaters in the reservoir of plastic material.

The other advantages and characteristics of the present invention will emerge from reading the description below, in conjunction with the attached drawings, namely:

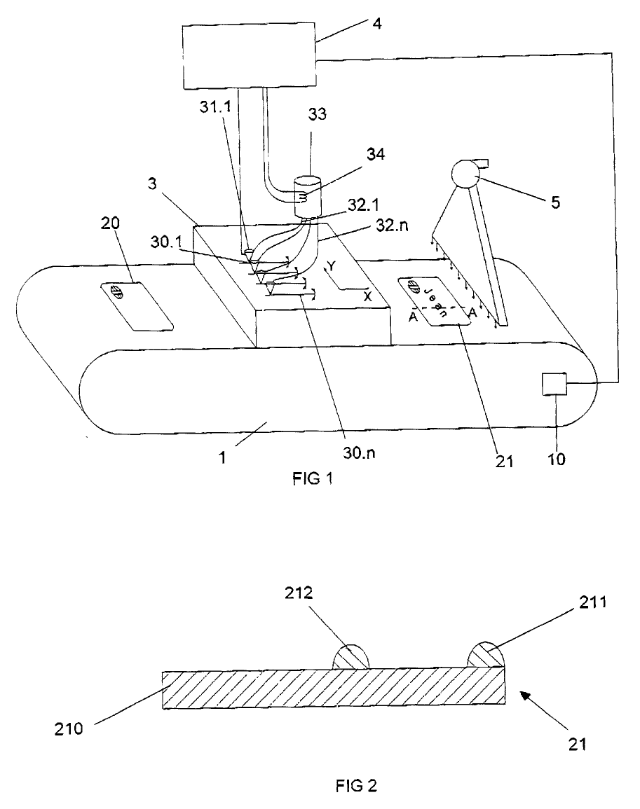

FIG. 1, showing a perspective view of the device enabling the invention to be implemented;

FIG. 2, showing a section on AA through the substrate with a relief inscription on it.

The invention will now be described with reference to FIGS. 1 and 2.

The device for applying relief inscriptions consists of a conveyor (1) for transporting plastic substrates (20), not bearing a relief inscription, towards a station (3) for applying relief inscriptions (1). The substrate (21) exiting from the station for applying relief inscriptions bears the information JEAN, for example, the first name of the user of the substrate. This example is given purely for illustrative purposes and the information in the relief inscription can be of any type, and may concern the user of the substrate or be any other information necessary for or appropriate to the use of the substrate. This relief inscription may also consist not just of alphanumeric information in any language, or of ideograms, but also of a specific code, such as a bar code, for example, or any other type of code used in industry.

The station for applying relief inscriptions comprises a number of nozzles (30.1 to 30.n), each fed by its own individual piping system (31.2, 32.n) with fluidised plastic from a reservoir (33) incorporating a heater (34) to control the material fluidity. The heater (34) is connected to a control unit (4) which itself is connected to the means (10) of controlling the transfer device at a pre-determined speed. Each nozzle (30.1 to 30.n) comprises, for example, a tube to which a vibratory motion is imparted by a piezoelectric system (31) which vibrates the tube in a direction “y” transverse to the direction “x” of movement of the substrates (20). By forming the cavity into which the fluidised plastic material flows, each piezoelectric element (31.1 to 31.n) also enables the plastic material to be propelled towards the end of the tube in order to ensure that it is deposited or projected onto the substrate. The mechanical and oscillatory characteristics of the system are determined and controlled for each ejector head by the control device connected to each head. The frequency of the oscillations and the speed of movement of the substrates are controlled by the control unit (4) in order to enable drops of molten plastic material to be deposited at the desired places on the substrate in such a way that a series of successive drops, deposited one after the other while the substrate card is being moved in front of each of the heads and the head is being moved in a transverse direction, create a representation of alphanumeric characters or ideograms on bar codes or specific codes. The plastic material deposited is of a sufficient temperature to melt the surface of the substrate slightly and for the material deposited to become integral with the material comprising the substrate. At the exit from the relief inscription station, each substrate passes in front of a cooler (5) to ensure rapid solidification so as to avoid any deformation of the relief obtained. As FIG. 2 shows, the substrates so obtained incorporate a relief inscription (211, 212), the raised area (211) forming the upper part of the letter A and the raised area (212) forming the lower part of the letter on the section.

One of the techniques that may be used for the fluidised plastic ejector nozzles is that disclosed in patent application PCT WO 99/46126. Any other technique, particularly an inkjet allowing a quantity of fluid material to be deposited at a specified place in a selective and instant manner, may also be used. The deposition viscosity/temperature combination will be a variable parameter, controlled by the control unit (4) as a function of the chemical family of the substrate. The material of variable viscosity may be an ink dried by UV radiation or by infrared rays. In this case, the cold airflow diffusion station (5) is replaced by a UV radiation dryer or by infrared radiation. The viscosity material can also be a resin dried by UV radiation or by infrared radiation. This material may also be of the same chemical family as the card and of the PCV, PET (polyethylene teraphthalate) PETG (polyethylene teraphthalate glycol), PETF (polyethylene teraphthalate film), APET (amorphe polyethylene teraphthalate), ABS, PE (polyethylene), PS (polystyrene), or PP (polypropylene) type. In one embodiment, the reservoir (33) and the heater (34) can be replaced by a built-in extruder allowing the material to be deposited to be supplied in paste or liquid form. This solution will be selected especially in the case where the material used is of the same chemical family as the substrate. The deposition temperature on the substrate will be slightly above the Vicat point of the material comprising the substrate, in order to obtain chemical cohesion between the characters forming the relief and the card. Instead of needles of a suitable diameter subjected to electronically-controlled vibrations, a metering valve relief material deposit system can be also be imagined, whereby the material of variable viscosity is sent to a fluid chamber in which the viscosity, temperature, flow quantity and vacuum obtained are combined in order deposit these materials of variable viscosity accurately on the surface. The control system for the writing head comprises a computer sending digital data to be inscribed in relief of the substrate. This digital data is then converted into electronic signals, and combined with piezoelectric phenomena to enable accurate control of the dimensioning and deposition of the drops. This technique has the advantage that the reverse of the card is not deformed, and the card is not subjected to mechanical stress resulting from pressure. The technique allows an unlimited choice of character fonts and colours. Colouring the substance constituting the characters allows the life of the colour to be increased. Each line of characters can have a different colour, and it is sufficient for this to provide a supply of a different coloured material to each separate nozzle. In the same way as in the example given, the nozzles write in continuous streams, but it is clear that one could equally well decide to assign each nozzle to one line of print and change the orientation of the substrates. This technique allows relief characters to be formed on any substrate, especially cards, whether laminated or not, or injected. Furthermore, it allows relief characters to be applied on so-called proximity cards. With smart cards or even cards with microprocessors or microcontrollers, it is necessary to establish a connection between the card and the card reader. In general, this contact has so far been effected by a contact surface constituting a terminal, but new technologies are planned allowing the manufacture of proximity cards that can communicate with a terminal by means either of radio frequencies or magnetic or electrostatic signals. Embossing is difficult to achieve on such cards, as it can destroy the antennae or magnetic loops that effect the transmissions. It will be realised that this relief inscription technology makes advantageous non-destructive inscriptions possible for such cards.

It must be clear for persons skilled in the art that the present invention permits embodiments in numerous other specific forms without departing from the field of application of the invention as claimed. Consequently, the present embodiments must be regarded as illustrative, but can be modified within the defined field by the import of the attached claims.

1. Method of applying inscriptions in relief to substrates made of plastic, comprising:
a step in which a plastic material of variable viscosity is deposited in real time in a single operation, only at those places that form the relief inscription, at a sufficient temperature to ensure a physical-chemical bond with the material comprising the substrate,
a cooling step for the material deposited.

2. Inscription method as in claim 1, characterised by the fact that the substrate is a magnetic card.

3. Inscription method as in claim 1, characterised by the fact that the substrate is a smart card.

4. Inscription method as in claim 1, characterised by the fact that the substrate is a badge.

5. Inscription method as in claims 1 to 4, characterised by the fact that the method comprises a control step for a number (30.1 to 30.n) of vibrating elements in the form of tubes, supplied with fluidised plastic material from a reservoir (33), the vibration of these tubes being synchronised and controlled at frequencies to produce the deposition of drops of fluidised plastic material at the places necessary for a number of deposited drops to form an alphanumeric character or logo or increased thickness or any other form of raised area.

6. Inscription method as in claims 1 to 5, characterised by the fact that the relief inscription may constitute a bar code.

7. Inscription method as in claims 1 to 5, characterised by the fact that the relief inscription may constitute other codes carrying information concerning the substrate or the user of the substrate

8. Inscription method as in claims 1 to 7, characterised by the fact that the control of the deposition of the drops is effected as a function of the speed at which the substrates pass by in front of the ends of the print heads (30.1 to 30.n).

9. Inscription method characterised by the fact that it incorporates a means (1) of moving the substrate (21), made of plastic, in front of a print station (3) equipped with a number of nozzles (30.3 to 30.n) which eject drops of plastic material of variable viscosity, the said drops forming relief points on the substrate, with the ejector nozzles being fitted with a means (4) of controlling the positioning of the drops in a direction transverse to that of the movement of the substrates, and also a means of controlling the ejection duration of each drop as a function of both the speed of travel of the substrates and the data constituting the inscription.

10. Device as in claim 9, characterised by the fact that it includes a cooling station (5) for the fluidised plastic material.

11. Device as in claims 9 or 10, characterised by the fact that the deposition station (4) includes a control unit (4) connected both to the means of controlling the transfer speed of the substrates (20) in front of the inscription station (3), and to each of the ejector nozzles (30.1 to 30.n) for fluidised plastic material.
